(19) United States
(12) Patent Application Publication
(10) Pub. No.: US 2005/0045747 A1
(43) Pub. Date: Mar. 3, 2005

(54) Method and apparatus for high pressure water jet lancing of foreign materials from surfaces of a nuclear power reactor

(75) Inventor: Charles S. Hacquebord, Chelmsford, MA (US)

Correspondence Address: KUDIRKA & JOBSE, LLP, ONE STATE STREET, SUITE 800, BOSTON, MA, 02109, US

(73) Assignee: Hennigan Engineering Company, Inc., Hingham, MA (US)

(21) Appl. No.: 10/625,988

(22) Filed: Jul. 24, 2003

Related U.S. Application Data
(60) Provisional application No. 60/405,384, filed on Aug. 23, 2002.

(51) Int. Cl. B05B 7/02; B05B 9/01; B05B 15/08

(52) U.S. Cl. 239/525; 239/587.1; 239/587.5

(57) ABSTRACT

A remotely controllable apparatus and technique for the removal of “CRUD” from surfaces within a nuclear Reactor Pressure Vessel includes a flexible, high pressure water jetting lance assembly for delivering intense water pressure (up to 20,000 psi) via nozzle(s) directly to the areas containing the highly radioactive “CRUD” material. The jetting lance assembly is positioned to the contamination site with either a guide tube having any predetermined shape and into which the lance assembly is disposed or a positioning member attached to the lance assembly, either of which may be torqued and manipulated until the nozzle end of the lance assembly is in position. Various other embodiments include multiple nozzles, adapters that have a specific shaped lumen, one or more sensor devices is communication with processing units near the proximal end of the apparatus.

### RELATED APPLICATIONS

This application claims priority to United States Provisional Patent Application Ser. No. 60/405,384, filed Aug. 23, 2002, by Charles S. Hacquebord, entitled Method and Apparatus for Decontamination of Nuclear Reactor, the subject matter of which is incorporated herein by reference for all purposes.

### FIELD OF THE INVENTION

This invention relates to apparatus for decontamination radioactive material, and, more specifically, to a remotely controllable apparatus for the removal of “CRUD” from the nozzles and thermal sleeves of a nuclear reactor pressure vessel.

### BACKGROUND OF THE INVENTION

Nuclear reactors require periodic maintenance and inspection to operate safely. Part of such maintenance includes the inspection of welds and components within the reactor pressure vessel. In doing so, personnel are subjected to high levels of radiation (dose). Therefore removal of CRUD from various reactor surfaces is required to provide a low dose and safe working environment for the workers. “CRUD” is a colloquial term for corrosion and wear products, rust particles, etc. that become radioactive when exposed to radiation. The term is actually an acronym for Chalk River Unidentified Deposits, the Canadian nuclear plant at which the activated deposits were first discovered. Removal of CRUD helps to reduce the potential radiation dose to personnel during inspection and maintenance of nuclear reactors. However, because of the size, shape and design of many reactors, coupled with the fact that the reactor or portions thereof are immersed in water, the removal process can be difficult to perform.

Referring to FIG. 1, a boiling water nuclear power reactor pressure vessel 10 normally has a cylindrical shape closed at both ends with a removal top head. Typically, a core shroud, that is cylindrical in shape, surrounds the core plate with a shroud support. During normal operation recirculation flow within the pressure vessel must be maintained. A large amount of heat is generated within the pressure vessel resulting with high thermal temperatures within the vicinity of thermal sleeves and nozzles 14 resulting in adhesion of the highly radioactive deposits known as CRUD. Specifically, CRUD accumulates along the surfaces of an annular cavity 16 defined between the thermal sleeves 14 and nozzles and the reactor wall 10. These formations and deposits are very undesirable when maintenance and inspections are being performed and can result in high rates of radiation dosage to personnel. The “N-2” nozzles and thermal sleeve are part of the recirculating water system that enters the pressure vessel 10 through an inlet nozzle that is coupled to a jet pump riser pipe 12. The jet pump riser 12 includes a lower elbow 12A and thermal sleeve 14 that is attached, typically welded, in place so that the riser pipe is vertical and parallel to the shroud and sidewall of vessel 10. Because of the size, shape and water depth of the spaces in which the CRUD accumulates it is very difficult to effectively remove all CRUD prior to maintenance and inspections of the reactor. The apparatus for removal of CRUD has to be remotely controlled to prevent high rates of radiation dosage to operating personnel. In addition, the access paths to the remote locations in which CRUD accumulates are often at least partially obstructed with other elements, e.g. plates, brackets, etc. which increased the difficulty in accessing the site of the CRUD. In addition to the specific jet pump and thermal sleeve/nozzle configuration illustrated in FIG. 1, CRUD accumulation occurs in and around all other nozzles within the reactor.

Accordingly, a need exits for an apparatus and technique to remove CRUD from hard to access spaces along the surface of a nuclear reactor.

A further need exits for an apparatus that can be remotely directed to remove CRUD from hard to access spaces along the surface of a nuclear reactor.

### SUMMARY OF THE INVENTION

The present invention discloses a remotely controllable apparatus and technique for the removal of “CRUD” from the annulus area around and inside the thermal sleeve at the lower elbow assembly of the jet pump riser pipe assembly and other nozzle configurations and surfaces within a nuclear Reactor Pressure Vessel. The inventive apparatus comprises a flexible, high pressure water jetting lance assembly for delivering intense water pressure (up to 20,000 psi) via nozzle(s) directly to the areas containing the highly radioactive “CRUD” material, thereby causing excision of the CRUD. The flexible lance assembly is positioned to the contamination site with either a guide tube having any predetermined shape or a positioning member, either of which may be torqued and manipulated until the nozzle end of the lance assembly is in position.

According to one aspect of the invention, an apparatus for removal of contaminants from remote surfaces comprises: an elongate delivery tube having a lumen extending therethrough and having a first end and a second end connectable to a source of high pressured fluid to allow fluid communication with the delivery tube lumen; a nozzle operatively coupled to the first end of the delivery tube, the nozzle having at least one orifice in fluid communication with the delivery tube lumen; and means for positioning the nozzle in the proximity of the contaminants. In one embodiment of the invention, the means for positioning the nozzle comprises an elongate guide tube having a lumen extending therethrough and into which the elongate delivery tube is disposed. The guide tube may have a distal portion thereof with a bend radius that deviates from the main axis of the guide tube by an off axis angle of between 0° and 180°. In another embodiment, the means for positioning the nozzle comprises an elongate positioning member and means for securing the positioning member to the elongate delivery tube. In various other embodiments, the apparatus further comprises an adaptor with either an L-shaped or T-shaped lumen operatively coupling one or more nozzles to the delivery tube, or, any of a sensor, transducer, and imaging device carried at the distal end of the guide tube and operatively coupled to a processing unit at the proximal end of the guide tube.

According to a second aspect of the invention, a method for removal of contaminants from remote surfaces comprises: (a) providing the high pressure lancing apparatus comprising: (i) an elongate delivery tube having a lumen extending therethrough and having a first end and a second end connectable to a source of high pressure fluid so as to allow fluid communication with the delivery tube lumen, the delivery tube having a second end, (ii) a nozzle operatively coupled to the first of end of the delivery tube and having at least one orifice in fluid communication with the lumen of the delivery tube, and (iii) means for positioning the nozzle; (b) manipulating the means for positioning the nozzle so that the nozzle is disposed in proximity of the contaminants; (c) providing high pressure fluid from a source to the lumen of the elongate delivery tube; and (d) directing high pressure fluid emanating from the nozzle toward the contaminants.

According to one embodiment of the method, the means for positioning the nozzle comprises an elongate guide tube having a lumen extending therethrough and into which the elongate delivery tube is disposed and wherein (b) comprises: (b1) positioning a distal end of the guide tube in the proximity of the contaminants; and (b2) manipulating the elongate delivery tube within the lumen of the guide tube so that the nozzle extends beyond the distal end of the guide tube. According to another embodiment of the method, the means for positioning the nozzle comprises an elongate positioning member secured to the elongate delivery tube and wherein (b) comprises: (b1) manipulating the elongate positioning member so that the nozzle is disposed in proximity of the contaminants. According to yet another embodiment of the method, the nozzle of the lancing apparatus has a plurality of orifices and wherein (b) comprises: (b1) directing high pressure fluid from one of the nozzle orifices in a direction other than the toward the contaminants.

According to still another embodiment of the method, the lancing apparatus further comprises a plurality of nozzles operatively coupled to the elongate delivery tube and in fluid communication with the lumen of the elongate delivery tube and wherein (b) comprises:(b1) directing high pressure fluid from one of the nozzles in a direction substantially opposite the direction from which high pressure fluid is emanating from another of the plurality of nozzles. According yet another embodiment of the method, the lancing apparatus further comprises a sensor carried near the first end of the elongate delivery tube and in communication with a processing unit near the second end of the elongate delivery tube and wherein the method further comprises: (e)sensing a condition in the proximity of the nozzle; and (f) transmitting signals associated with the condition from the sensor to the processing unit.

### BRIEF DESCRIPTION OF THE DRAWINGS

The above and further advantages of the invention may be better understood by referring to the following description in conjunction with the accompanying drawings in which:

FIG. 1 illustrates a nuclear reactor jet pump riser pipe and thermal sleeve area showing the space in which CRUD accumulates, in relation to the decontamination apparatus of the present invention.

FIG. 2 is a side, partially cutaway view of the decontamination apparatus illustrating a jet lance assembly with a nozzle head in relation to the guide tube in accordance with the present invention;

FIG. 3 illustrates the flexible jet lance/nozzle assembly disengaged from a guide tube in accordance with the present invention;

FIG. 4 is a side, partially cutaway view of another embodiment of the decontamination apparatus of the present invention illustrating the flexible jet lance with a nozzle head in relation to a guide tube having a bend radius;

FIG. 5 is a side, partially cutaway view of an alternative embodiment of the decontamination apparatus of FIG. 4 illustrating the rigid jet lance with a nozzle head in relation to the guide tube having a bend radius;

FIG. 6 is a side, partially cutaway view of another embodiment of the decontamination apparatus in accordance with the present invention illustrating the rigid jet lance with nozzle head in relation to the guide tube having no bend radius;

FIG. 7 is a side, partially cutaway view of an alternative embodiment of the decontamination apparatus of FIG. 6 illustrating the flexible jet lance with nozzle head in relation to the guide tube having no bend radius;

FIG. 8 is a side, partially cutaway view of another embodiment of the decontamination apparatus in accordance with the present invention illustrating a T-block adapter with a two nozzle, balanced zero thrust head;

FIG. 9A is a side, partially cutaway view of an alternative embodiment of the decontamination apparatus of FIG. 8 illustrating a T-block adapter with a balanced zero thrust nozzle head in relation to the guide tube, feeder lance and a rigid cleaning lance;

FIG. 9B is a side, partially cutaway view of an alternative embodiment of the decontamination apparatus of FIG. 8 illustrating an L-block adapter with single nozzle head in relation to the guide tube, feeder lance and a rigid cleaning; on

FIG. 10A is a side, partially cutaway view of an alternative embodiment of the decontamination apparatus of FIG. 9 illustrating an L-block adapter with a nozzle head in relation to the guide tube, feeder lance and a flexible cleaning lance;

FIG. 10B is a side, partially cutaway view of an alternative embodiment of the decontamination apparatus of FIG. 9 illustrating an L-block adapter with a nozzle head in relation to the guide tube, feeder lance and a rigid cleaning lance;

FIG. 11 is a side view of an alternative embodiment of the decontamination apparatus of FIG. 10A illustrating a positioning member attached to the elongate delivery tube (feeder lance);

FIG. 12 is a side view of an alternative embodiment of the decontamination apparatus of FIG. 10B illustrating a positioning member attached to the elongate delivery tube (feeder lance) in relation to an L-block adapter with a nozzle head and a rigid cleaning lance;

FIG. 13 is a side view of an alternative embodiment of the decontamination apparatus of FIG. 9 illustrating a positioning member attached to the elongate delivery tube (feeder lance) in relation to a T-block adapter with a zero thrust nozzle head and a rigid cleaning lance;

FIGS. 14A-L illustrates various nozzle head configurations and the directions of the jet streams emanating therefrom; and

FIGS. 15A-C are side, partially cutaway views of alternative embodiments of the decontamination apparatus of FIG. 4 illustrating configurations of the guide tube with various bend radii.

### DETAILED DESCRIPTION

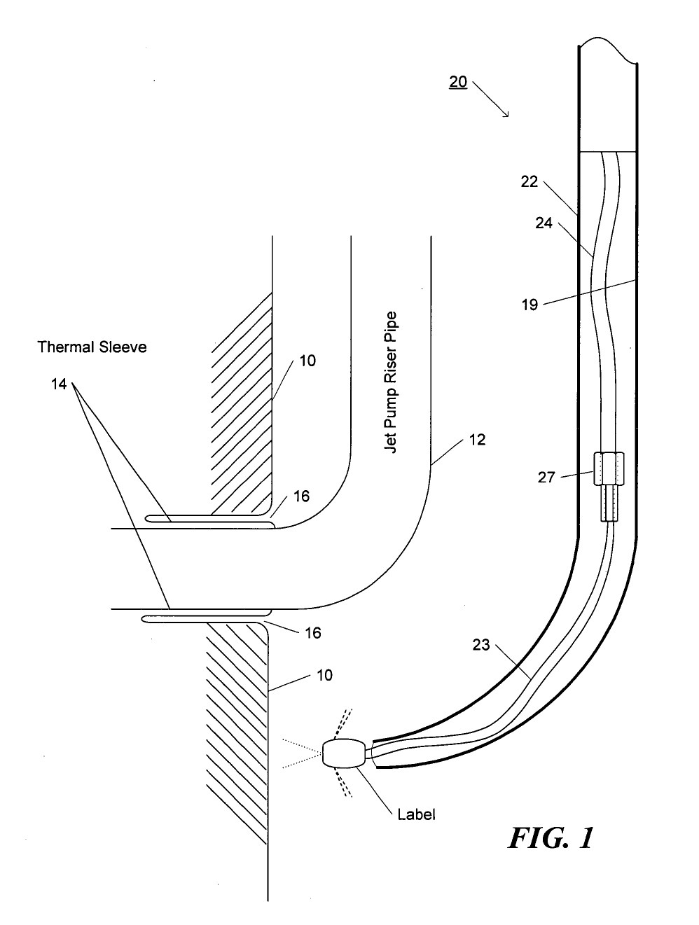

FIGS. 1-3 illustrate a remotely controllable apparatus 20 for the removal of “CRUD” from remote areas of limited accessibility within a nuclear Reactor Vessel, including the annulus area around and inside the thermal sleeve at the lower elbow assembly of the jet pump riser pipe assembly. The apparatus 20 comprises a multi-section guide tube assembly 22 encasing a high pressure water jetting lance assembly 25 comprising a feeder lance 24 intercoupled to a cleaning lance 23 which carries a nozzle 26 at an end thereof. The more proximal end of lance assembly 25, feeder lance 24, is attachable to a high pressure pump system 7 with a working pressure capability of 20,000 psi, through appropriate couplings rated for the working pressure, as determined by the designer. In apparatus 20, the jetting lance assembly 25 is movably disposed within a central lumen 19 of guide tube 22 to enable the positioning of cleaning lance 23 and nozzle 26 relative to do the distal tip of the guide tube 22.

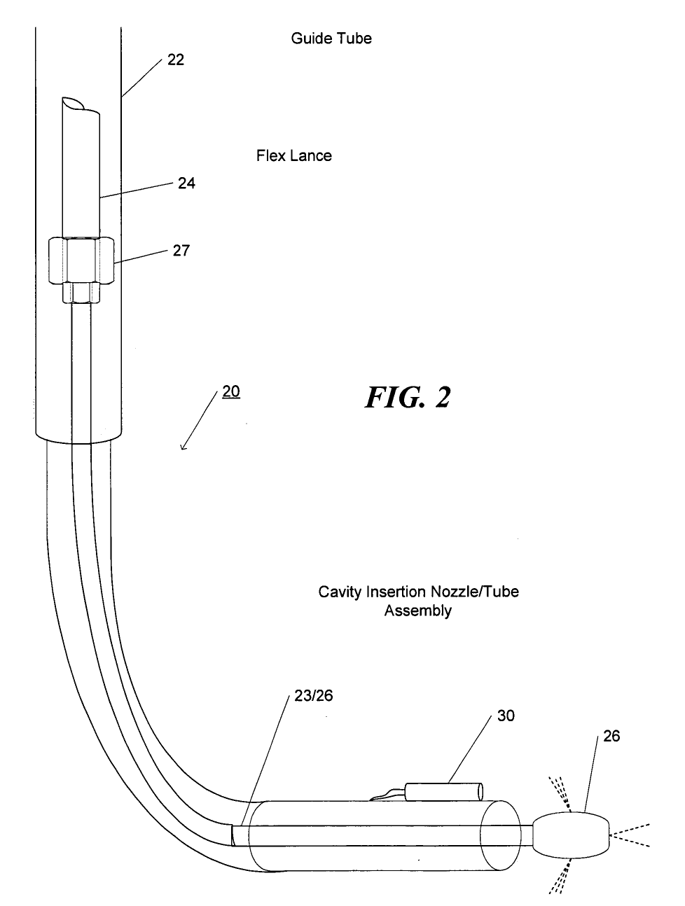

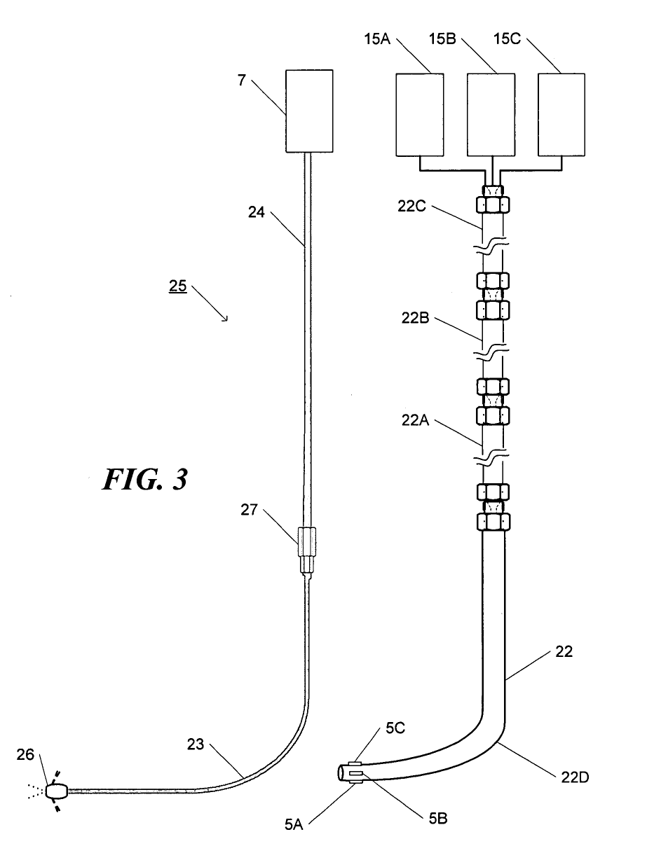

The guide tube 22 is an elongate cylindrical member having a lumen 19 extending the length thereof that acts as a protective housing and positioning mechanism for the high pressure water jetting lance assembly 25. Guide tube 22 may be fabricated from a titanium alloy to achieve a maximum strength/weight ratio. The distal region of guide tube 22 near the open end has a curved segment or elbow 22D to position the jetting lance assembly 25 in the direction of the work surface. Drain holes, not shown, may be incorporated in much of the length of the tube to further reduce the overall weight and to minimize the possible spread of contaminates during the water-jetting process and when retrieving the assembly. These drain holes allow for the flooding of the guide tube to prevent radiation exposure or “shine” and protect the working technicians from high dose exposure. As shown in FIG. 3, the guide tube 22 may be implemented with a multisection assembly. In such embodiment, the section 22A-D are connected with appropriate coupling mechanisms. Further, the diameter of guide tube 22 may be progressively reduced, as illustrated in FIG. 2.

Jetting lance assembly 25 comprises feeder lance 24, insertion nozzle 26 and cleaning lance 23. Feeder lance 24 is an elongate, flexible cylindrical member having a lumen extending the length thereof that acts as a conduit to deliver high pressure fluid to the cleaning lance/nozzle assembly to which it is coupled. The material from which the feeder lance 24 is manufactured may be flexible but strong enough to deliver working water pressure of 20,000 psi therethrough. Feeder lance 24 may be connected to cleaning lance 23 through a reducer coupling 27, as illustrated in FIG. 2.

The insertion nozzle 26 is designed with pre-calculated orifice sizes and angles of attack to determine flow and pressure, based on the actual dimensions of the cavity 16 or other space to be treated. These calculations are then used to determine the size and type of lance 24 to minimize the pressure losses and maximize the effectiveness of the water jets. The position of the jet orifices within nozzle 26 are designed to assist with both navigation of the nozzle into the cavity and directing water fluid flow.

As apparatus 20 is a remotely-operated assembly, a video camera 30 may be attached to the outside of the distal end of the guide tube 22 to assist with positioning and can be coupled through appropriate signal paths to a system having recording capabilities for historical data retrieval.

Guide tube 22 in conjunction with the unique flex lance and insertion nozzle design allows the high pressure water jets to generate the energy directly to the walls from within the small annular areas resulting in a more effective removal of the “CRUD” material. Such applications are typically performed under water at various depths dependent on the location and position of the nozzle or sleeve to be flushed, and with the feed and retrieve performed at a low dose area.

A high pressure positive displacement pumping system is attached to lancing assembly 25 of apparatus 20 to supply the decontamination apparatus with high pressure water capability of 20,000 psi. Pressure and flow may be controlled with the use of a high pressure water regulator adjusted with a nitrogen gas bladder assembly and a valve/valve seat component. The high pressure water may be controlled with a positive shutoff valve that stops all high pressure water flow to the jetting device when cleaning is not taking place. This feature also keeps the addition of water to the reactor vessel at a minimum, thereby reducing additional filtration requirements. In the contemplated embodiment, apparatus 20 is a multipart assembly with special fittings to assure FME (Foreign Material Exclusion) adherence and ability to disassemble for storage.

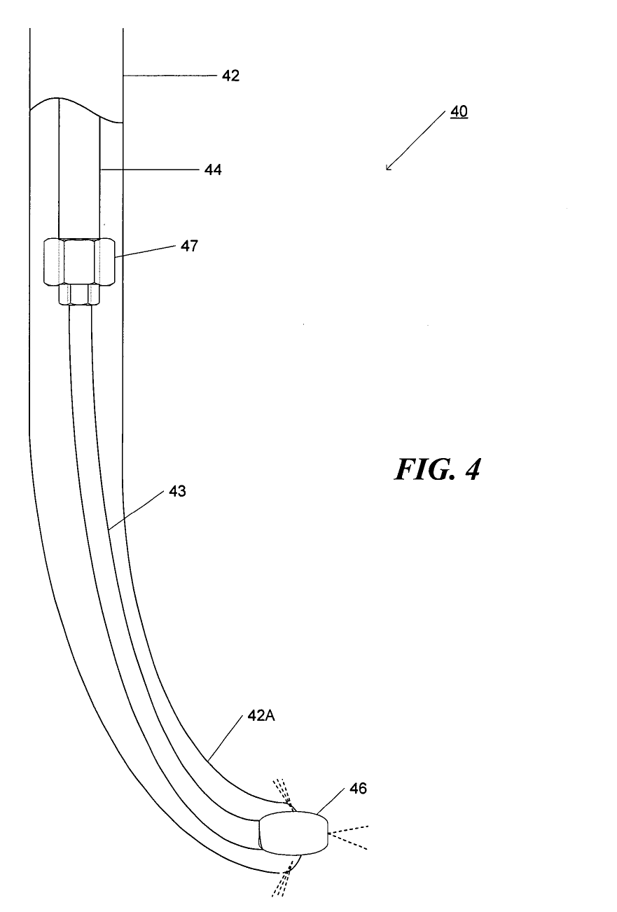

FIG. 4 illustrates another embodiment of the decontamination apparatus in which the guide tube has a bend radius. Specifically, in this embodiment, the decontamination apparatus 40 comprises the guide tube 42, flexible feeder lance 44, cleaning lance 43, and adapter 47 similar in construction, function and configuration to elements 22, 24, 23 and 27, respectively, of the apparatus 20, illustrated in FIG. 2. The guide tube 42 may be implemented in a multi-section assembly, similar to that shown in FIG. 3. In addition, the cleaning lance 43 may be part of a jetting lance assembly similar to assembly 25, as previously described.

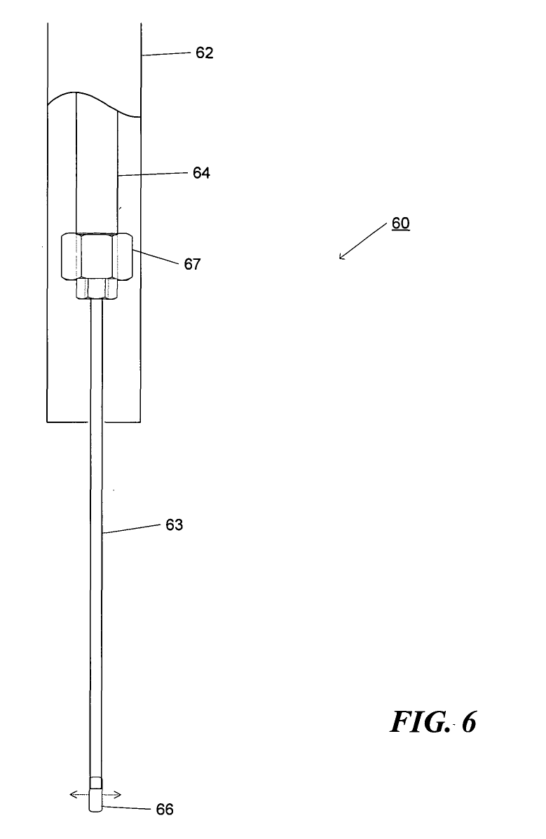

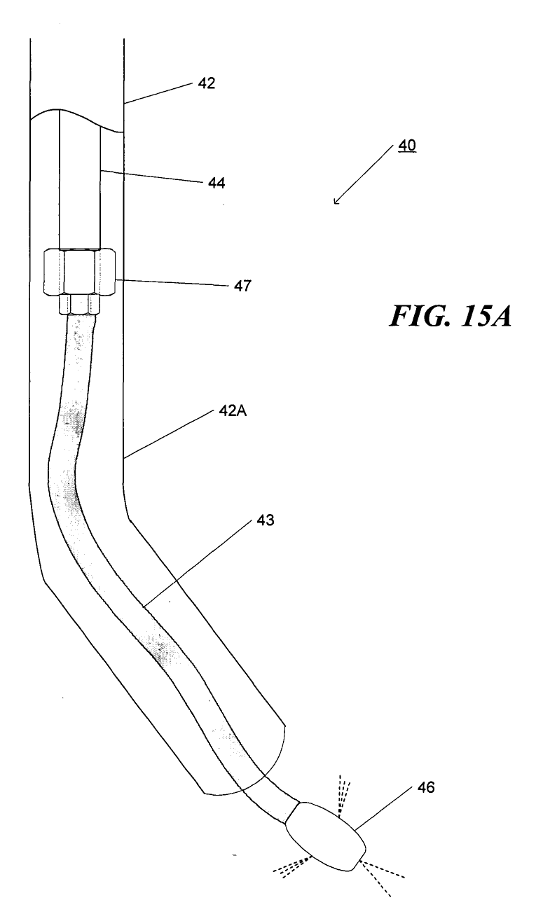

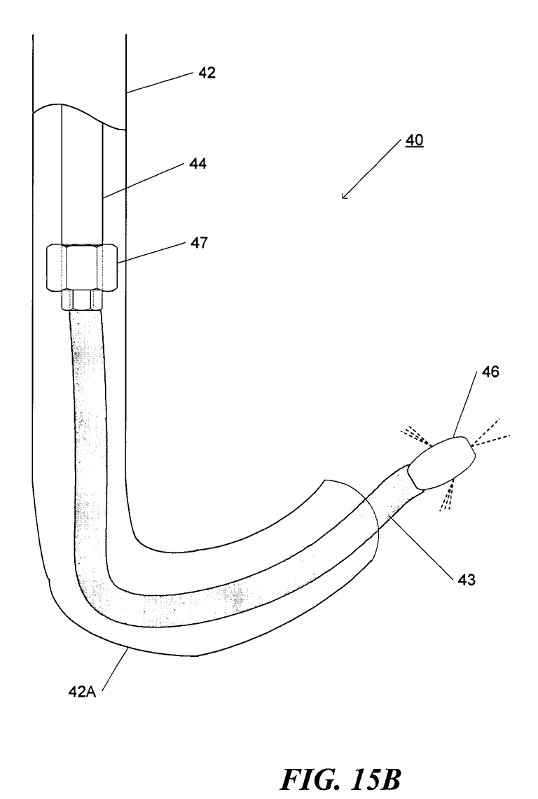

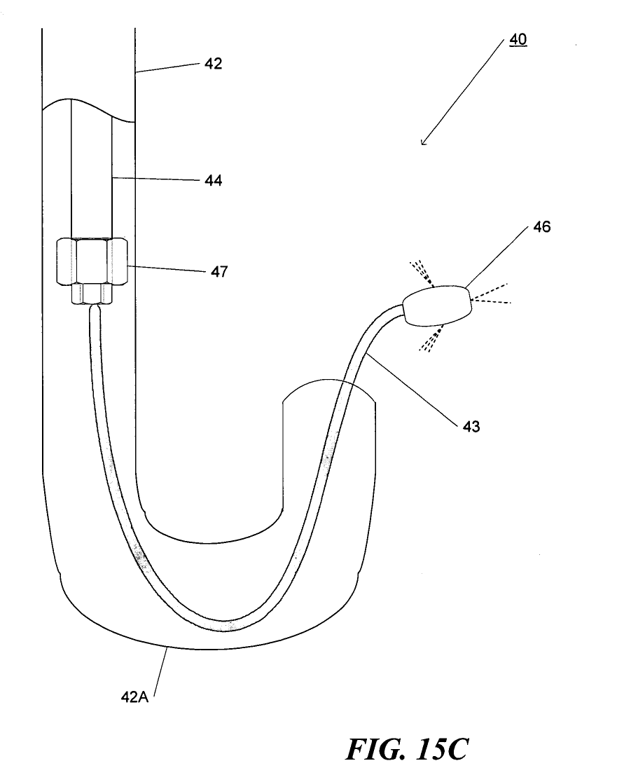

In the embodiment illustrated in FIG. 4, a distal end section 42A of guide tube 42 has a preformed bend radius which allows the cleaning lance 43, and, specifically, the cleaning nozzle 46, to be directed at a broad range of angles relative to the axis of the main portion of the guide tube 42, as indicated by reference numeral 45. The embodiment Illustrated in FIG. 4 enables the cleaning nozzle 46 to be more readily positioned an advanced into remote sites of contamination. In this matter, the cleaning lance, and particularly nozzle 46, may be directed anywhere within a broad range of angles, as necessary to access remote locations of contamination to be removed. The range of angles afforded by the bend radius may be chosen by the designer and may be in the range of 0 through 180 degrees off axis from the main axis 45. These angles include configurations such as that Illustrated in FIG. 6 (0 degrees off axis), FIG. 15A (45 degrees off axis), FIG. 2 (90 degrees off axis), FIG. 15B (135 degrees off axis), and the J-shaped configuration of FIG. 15C (180 degrees off axis).

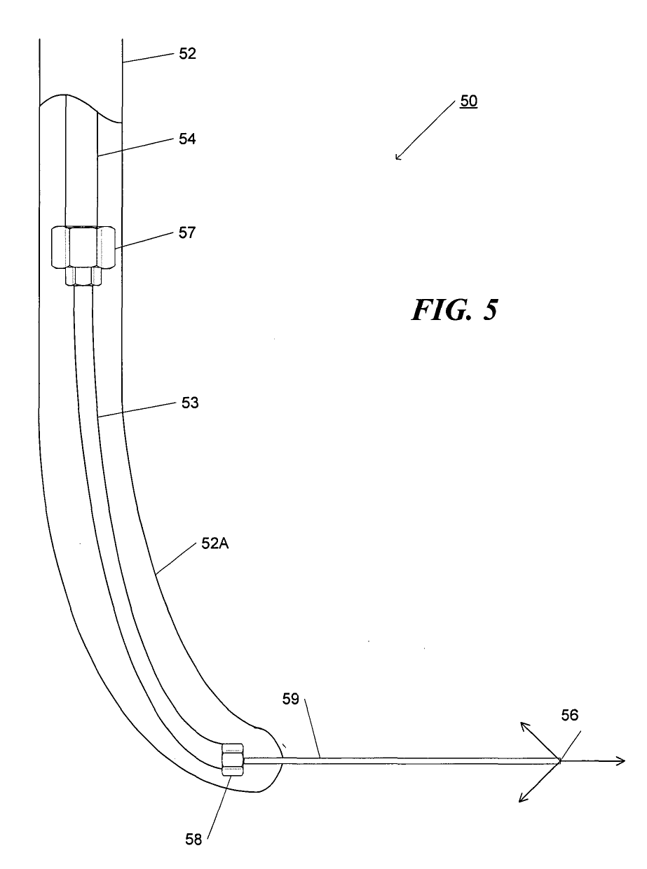

FIG. 5 is a view of an alternative embodiment of the decontamination apparatus of FIG. 4. Specifically, in this embodiment, the decontamination apparatus 50 comprises the guide tube 52, flexible feeder lance 54, cleaning lance 53, and adapter 57 similar in construction, function and configuration to elements 22, 24, 23 and 27, respectively, of the apparatus 20, illustrated in FIG. 2. The guide tube 52 may be implemented in a multi-section assembly, similar to that shown in FIG. 3. In addition, the cleaning lance 53 may be part of a jetting lance assembly similar to assembly 25, as previously described.

In the embodiment of FIG. 5, a rigid section 59, carrying a cleaning nozzle 56 at the distal end thereof, is coupled to cleaning lance 53 rigid jet lance with an adapter 58, as illustrated. The embodiment Illustrated in FIG. 5 enables the cleaning nozzle 56 to be advanced into remote sites of contamination that are greater distances from the distal opening of guide tube 52, and, that may be at the range of off axis angles from the main axis of the guide tube 52. The cleaning and jet 56 may include orifices which direct high pressure fluid move forward and at retrograde angles, as illustrated.

FIG. 6 is a view of another embodiment of the decontamination apparatus in accordance with the present invention illustrating the rigid jet lance with nozzle head in relation to the guide tube having no bend radius. Specifically, in this embodiment, a decontamination apparatus 60 comprises the guide tube 62, flexible feeder lance 64, rigid cleaning lance 63, and adapter 67 similar in construction, function and configuration to elements 22, 24, 23 and 27, respectively, of the apparatus 20, illustrated in FIG. 2. The guide tube 62 may be implemented in a multi-section assembly, similar to that shown in FIG. 3. In addition, the rigid cleaning lance 63 may be part of a jetting lance assembly similar to assembly 25, as previously described.

In the embodiment of FIG. 6, a cleaning lance 63 is substantially rigid and carries a cleaning nozzle 66 at the distal end thereof. Unlike the prior disclosed embodiments, the distal end of guide tube 62 has no bend radius which deviates from the axis 65 of the main portion of guide tube 62 . The embodiment illustrated in FIG. 6 enables the cleaning nozzle 66 to be advanced into remote sites of contamination that are greater distances from the distal opening of guide tube 62, and, that may be on axis with the main axis of the guide tube 62. The cleaning and jet 66 may include orifices which direct high pressure fluid at angles normal to the axis of the cleaning lance 63, as illustrated.

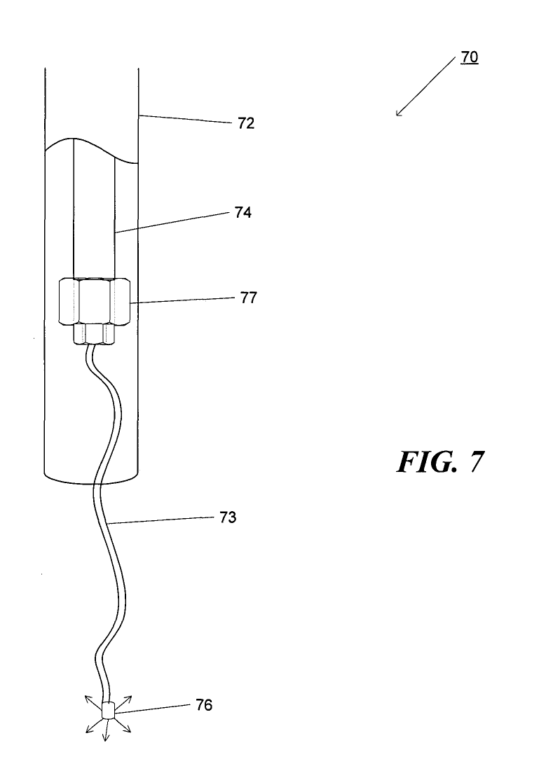

FIG. 7 is a view of an alternative embodiment of the decontamination apparatus of FIG. 6 illustrating the flexible jet lance with nozzle head in relation to the guide tube having no bend radius. Specifically, in this embodiment, a decontamination apparatus 70 comprises the guide tube 72, flexible feeder lance 74, flexible cleaning lance 73, and adapter 77 similar in construction, function and configuration to elements 22, 24, 23 and 27, respectively, of the apparatus 20, illustrated in FIG. 2. The guide tube 72 may be implemented in a multi-section assembly, similar to that shown in FIG. 3. In addition, the flexible cleaning lance 73 may be part of a jetting lance assembly similar to assembly 25, as previously described.

In the embodiment of FIG. 7, flexible cleaning lance 73 is substantially bendable and carries a cleaning nozzle 76 at the distal end thereof. Like the embodiment disclosed in FIG. 6, the distal end of guide tube 72 also has no bend radius which deviates from the axis 75 of the main portion of guide tube 72 . The embodiment Illustrated in FIG. 7 enables the cleaning nozzle 76 to be advanced into remote sites of contamination that are greater distances from the distal opening of guide tube 72, and, that may be off axis with the main axis 75 of the guide tube 72. The nozzle 76 may include orifices which direct high pressure fluid at a variety of angles relative to the axis of the nozzle 76, as illustrated.

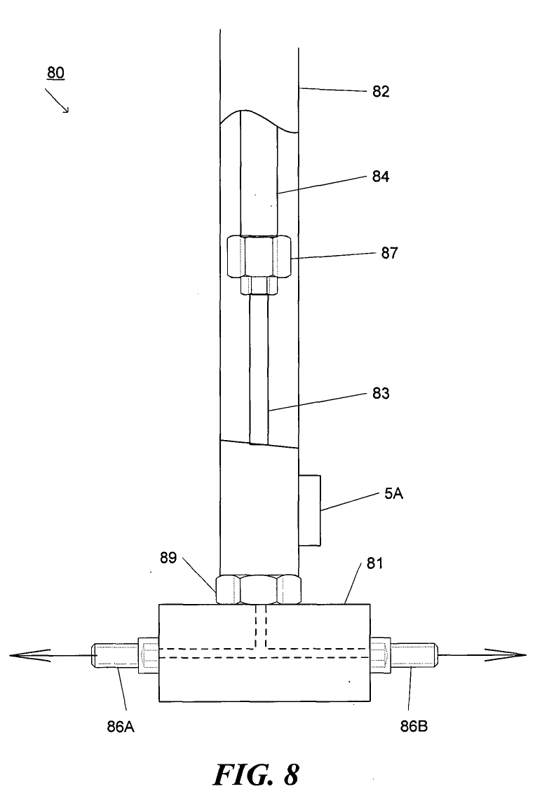

FIG. 8 is a view of another embodiment of the decontamination apparatus in accordance with the present invention illustrating a T-block adapter 81 with a pair of nozzle heads 86A-B in relation to the guide tube to achieve a balanced zero thrust reaction. Specifically, in this embodiment, a decontamination apparatus 80 comprises the guide tube 82, flexible feeder lance 84, a feeder lance 83, and adapter 87 similar in construction, function and configuration to elements 22, 24, 23 and 27, respectively, of the apparatus 20, illustrated in FIG. 2. The guide tube 82 may be implemented in a multi-section assembly, similar to that shown in FIG. 3. In addition, the feeder lance 83 may be part of a jetting lance assembly similar to assembly 25, as previously described.

In the embodiment of FIG. 8, T-block adapter 81 may be machined from a substantially rigid material such stainless steel, aluminum or titanium. T-block adapter 81 is coupled to feeder lance 83 through an adapter 89, as illustrated, which may be a separate component integrally formed with element 81. A T-shaped channel extends internally through adapter 81 and channels high pressure fluid from feeder lance 83 to nozzles 86A-B for a balanced zero thrust reaction, as illustrated in phantom. in FIG. 8. In the illustrative embodiment, nozzles 86A-B deliver high pressure fluid at angles substantially normal to the axis 85 of guide tube 82. Nozzles 86A-B may be balanced for zero thrust so that adapter 81 will not be repositioned from the locus of the contamination upon delivery of the high pressure fluid from either nozzle, i.e. the counterforce of a nozzle is canceled by that of the other nozzle. The embodiment illustrated in FIG. 8 enables the lancing of single or multiple surfaces simultaneously. A decontamination apparatus 80, including a T-block adapter 81, is used when access to nozzles, thermal sleeves, or other areas is greatly restricted with narrow (small) dimensions and the use of a bend radius insertion component would exceed the dimensions allowed.

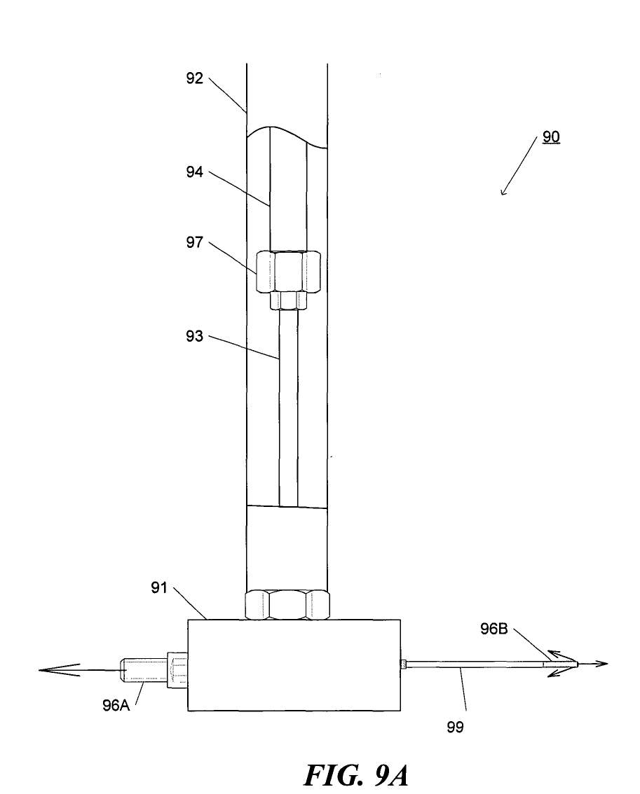

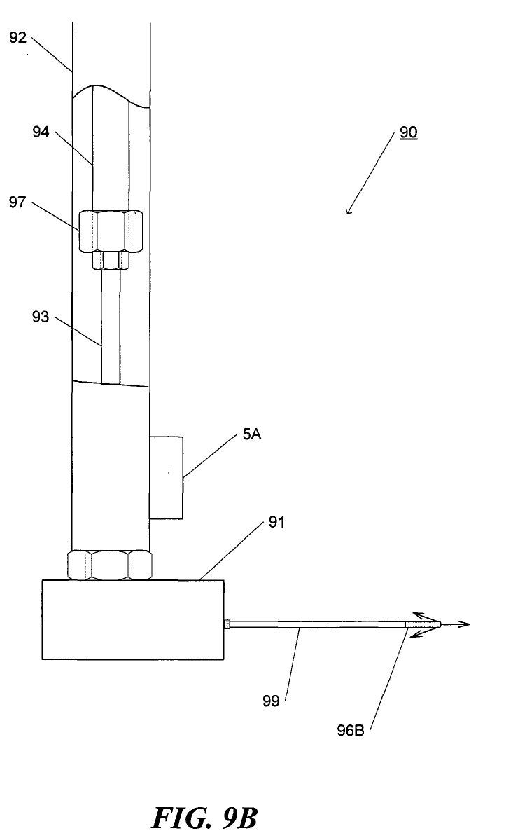

FIG. 9A is a view of an alternative embodiment of the decontamination apparatus of FIG. 8 illustrating a T-block adapter 91 in relation to the guide tube, a rigid cleaning lance 93. Specifically, in this embodiment, a decontamination apparatus 90 comprises the guide tube 92, flexible feeder lance 94, a rigid cleaning lance 93, and adapter 97 similar in construction, function and configuration to elements 22, 24, 23 and 27, respectively, of the apparatus 20, illustrated in FIG. 2. The guide tube 92 may be implemented in a multi-section assembly, similar to that shown in FIG. 3. In addition, the feeder lance 93 may be part of a jetting lance assembly similar to assembly 25, as previously described.

In the embodiment of FIG. 9A, T-block adapter 91 may be machined from a substantially rigid material such stainless steel, aluminum or titanium. T-block adapter 91 is coupled to feeder lance 93 through an adapter, as illustrated, which may be a separate component or integrally formed with element 91. As with adapter 81, a T-shaped channel extends internally through adapter 91 and channels high pressure fluid from feeder lance 93 to optional nozzle 96A and the assembly of cleaning lance 99/nozzle 96B. In the illustrative embodiment, nozzles 96A-B deliver high pressure fluid at angles substantially normal to axis 95 of guide tube 92. Nozzles 96A-B may be balanced for zero thrust so that adapter 91 will not be repositioned from the locus of the contamination upon delivery of the high pressure fluid from nozzle 96B, i.e. the counterforce of nozzle 96B is canceled by that of the optional nozzle 96A. In embodiments where rigid cleaning lance 99 is of a small enough diameter so that nozzle 96 will create minimal counterforce, nozzle 96A may be eliminated, As Illustrated in the embodiment of FIG. 9B.

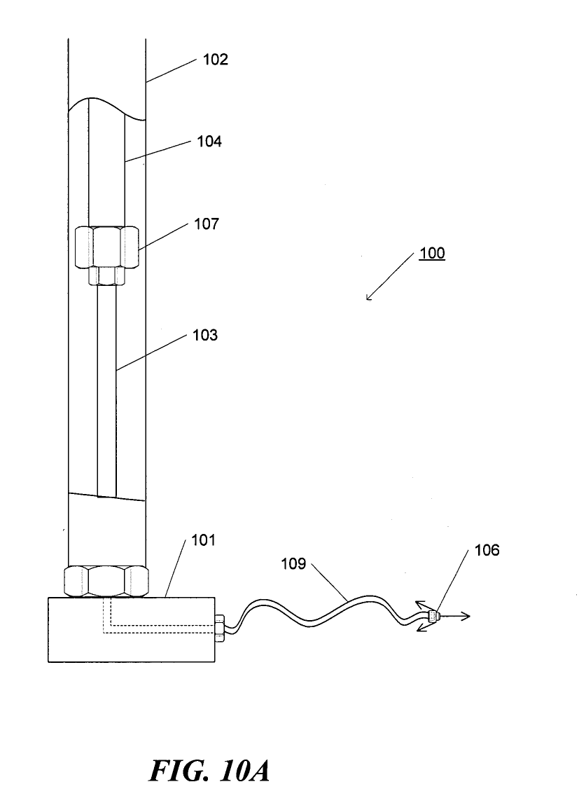

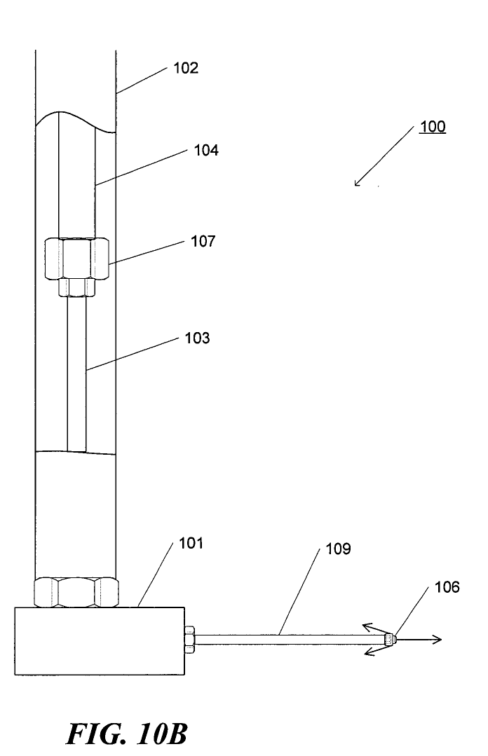

FIG. 10A is a view of an alternative embodiment of the decontamination apparatus of FIG. 9 illustrating an L-block adapter 101 in relation to the guide tube and flexible cleaning lance 109. Specifically, in this embodiment, a decontamination apparatus 100 comprises the guide tube 102, flexible feeder lance 104, a feeder lance 103, and adapter 107 similar in construction, function and configuration to elements 22, 24, 23 and 27, respectively, of the apparatus 20, it's illustrated in FIG. 2. The guide tube 102 may be implemented in a multi-section assembly, similar to that shown in FIG. 3. In addition, the feeder lance 103 may be part of a jetting lance assembly similar to assembly 25, as previously described.

In the embodiment of FIG. 10A, L-block adapter 101 may be machined from a substantially rigid material such stainless steel, aluminum or titanium. L-block adapter 101 is coupled to feeder lance 103 through an adapter, as illustrated, which may be a separate component or integrally formed with element 101. An L-shaped channel extends internally through adapter 101, as illustrated in phantom is FIG. 10A, and channels high pressure fluid from feeder lance 103 to flexible cleaning lance 109/nozzle 106. In the illustrative embodiment, nozzles 106 delivers high pressure fluid at angles substantially normal to axis 105 of guide tube 102. As with the other in embodiments of the invention which utilize a flexible cleaning lance and nozzle assembly, nozzle 106 may be balanced with retrograde thrust so that nozzle 106 will not be repositioned from the locus of the contamination upon delivery of the high pressure fluid therefrom. A decontamination apparatus 100, including an L-block adapter 101 is also used when access to nozzles, thermal sleeves, or other areas is greatly restricted with narrow(small) dimensions and the use of a bend radius insertion component would exceed the dimensions allowed.

FIG. 10B is a view of an alternative embodiment of the decontamination apparatus of FIG. 10A. The embodiment Illustrated in FIG. 10B is substantially similar to that illustrated in FIG. 10A, except that the cleaning lance 109 is rigid and carries at a distal end a nozzle 106 which may also be balanced with retrograde thrust so that nozzle 106 will not be repositioned from the locus of the contamination upon delivery of the high pressure fluid therefrom.

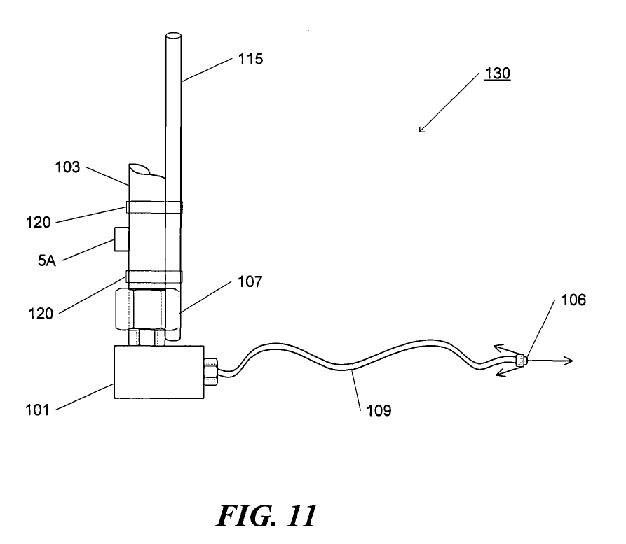

FIG. 11 is a view of an alternative embodiment of the decontamination apparatus of FIG. 10A illustrating a positioning member attached to the feeder lance. The embodiment of FIG. 11 is substantially similar to that illustrated in FIG. 10A, except that the guide tube 102 has been eliminated or truncated so that feeder lance 103 is attached to L-shaped adapter 101 through a modified adapter 107. In addition, a positioning member 115 is attached to feeder lance 103, as illustrated. In the illustrative embodiment, positioning member 115 may be either a cylindrical, tube-like member or a solid rod of substantially rigid material. The material from which member 115 is formed should be rigid enough to transmit torque applied to one end of the positioning member, yet flexible enough to be twisted along its respective axis. In the illustrative embodiment, positioning member 115 is attached to feeder lance 113 with one or more fasteners 120. Fasteners 120 may be implemented with any number of mechanisms which will secure the distal end of positioning member 115 to feeder lance 103 and/or guide tube 102, depending on the configuration of the apparatus 100. In the illustrative infighting, fasteners 120 mean the implemented with elastomeric bands, metal clips, etc. In addition to the positioning member 115, apparatus 100 may additionally include a modified adapter 107 which connects to L-shaped block 101, as illustrated. The apparatus 100 illustrated in FIG. 11 facilitates the passage or positioning L-shaped block 101 and nozzle 106 through narrow or partially obstructed access paths, as may be characteristic of the remote locations and which the CRUD accumulates.

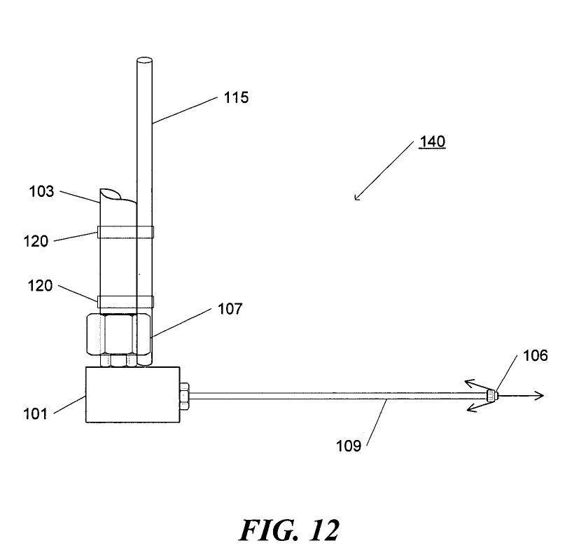

FIG. 12 is a side view of an alternative embodiment of the decontamination apparatus of FIG. 11 illustrating a positioning member attached to the guide tube in relation to an L-block adapter with a nozzle head and a rigid cleaning lance. The embodiment of FIG. 12 is substantially similar to that illustrated in FIG. 11, except that the assembly of flexible cleaning lance 103 and nozzle 106 has been replaced with the assembly of rigid cleaning lance 103 and nozzle 106, as illustrated. In this embodiment, rigid cleaning lance one of three and nozzle 16 are similar too the rigid cleaning lance and nozzle assemblies previously described.

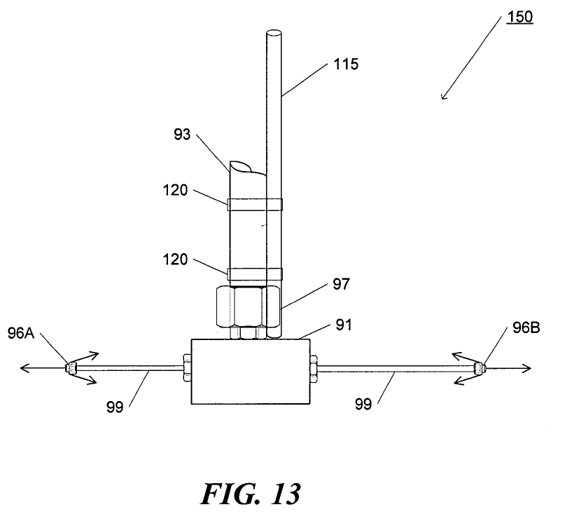

FIG. 13 is a view of an alternative embodiment of the decontamination apparatus of FIG. 9A illustrating a positioning member attached to the T-block adapter with a pair of rigid cleaning lance/nozzle assemblies. The embodiment of FIG. 13 is substantially similar to that illustrated in FIG. 10A, except that the guide tube 92 has been removed been eliminated or truncated so that feeder lance 93 is attached to an adapter 91 through a modified adapter 97. In addition, positioning member 115 is attached to feeder lance 93 by fasteners 120, as illustrated. In the embodiments disclosed in FIG. 13, a pair of rigid cleaning lances 99 are attached two to the block adapter 91. Each cleaning lance 99 carries at the distal end thereof a nozzle assembly 96B similar to that previously described with reference to FIG. 9A. In the embodiment illustrated in FIG. 13, the nozzles 106 may be balanced with retrograde thrust to avoid repositioning of the apparatus 130 from the locus of the contamination upon delivery of the high pressure fluid therefrom.

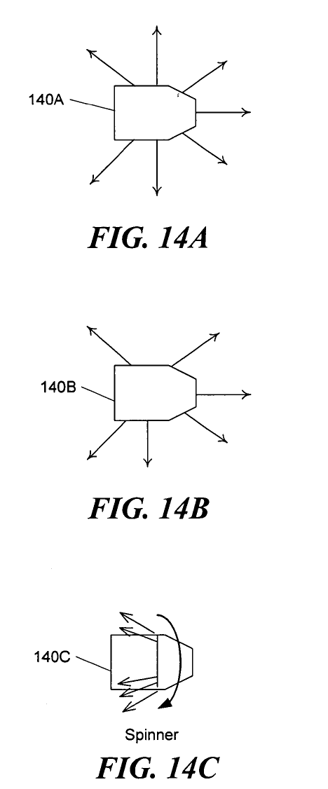

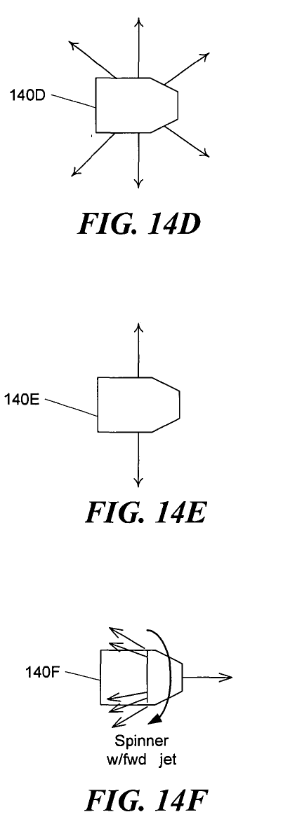

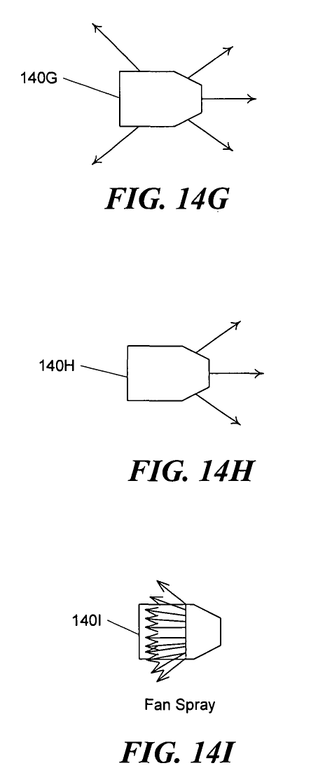

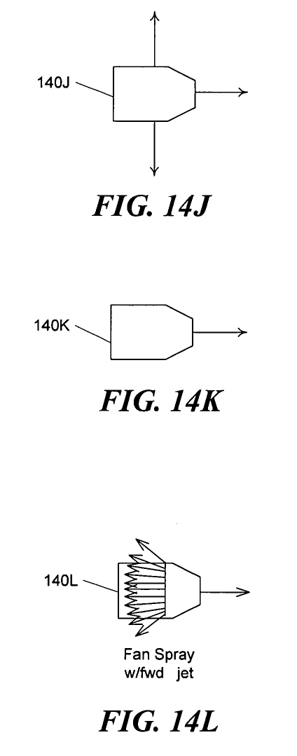

FIGS. 14A-L illustrate various nozzle head configurations of nozzles 140A-L, with the directions of the fluid jet streams emanating therefrom indicated with arrows. In the illustrative embodiments, nozzles 140A-L are generally cylindrical in shape with a diameter that papers generally in the distal direction along the main axis 141. The nozzles may the machine one or more rich materials including a plurality of different metals, and include a main lumen which communicates with the open of the feeder lance adapter described previously. The nozzles may be secured to the distal end of the feeder lance using conventional techniques. In the various embodiments, the main lumen (not shown) of each nozzle 140 may split into a plurality of separate lumens which open to the exterior surface of a nozzle, as illustrated by the directional arrows in Figures A-L. Nozzles 140C and 140F, as illustrated in FIGS. 14C and 14F, respectively, rotate relative to the main axis 145 of the nozzle. Nozzles 140I and 140L, as illustrated in FIGS. 14I and 14L, respectively, include a multiplicity of orifices which creates a retrograde fan pattern emanating radially from the cylindrical periphery of the nozzle 140, as illustrated. Any of the nozzle head configurations illustrated in FIGS. 14A-L may be utilize as a nozzle with any the apparatus disclosed herein. The selection of the nozzle, and, consequently, direction of the jet stream field, may be determined based on the nature of the cleaning lance one which the nose head is attached and the shape of the area to the lanced.

Any of the jet lancing apparatus disclosed herein may carry, in addition to the optical sensor 30 illustrated in FIG. 2 any number of sensors/tranducers, including thermal sensors, radioactivity sensors, electromagnetic sensors, acoustic sensors, singularly or in combinations with any number of transmitters, including optical sources, infrared sources, acoustic sources, etc, illustrated as transducers 5A-C in FIG. 3. For example, apparatus 40 of FIG. 4 may carry at the distal end of the guide tube 42 a radiation sensor 5A, a camera 5B, and an illumination source 5C, which may be coupled, via appropriate conductors/transmission mediums extending through the either the exterior or central lumen of guide tube 42, to processing units 15A-C, respectively, at the proximal end of the apparatus. In the illustrative embodiment, the conductors/transmission mediums connecting the sensors 5A-C to their perspective processing units 15A-C may be carried along the exterior of guide tube 22, within the interior of lumen of guide tube 22, or along the exterior of jetting lance assembly 25, as illustrated in FIGS. 8, 9A and 11, depending on the actual number and type of the sensors/transducers used and the designer's discretion. Alternatively, wireless sensors may be used and may not require the signal cabling extending through the length of the jet lancing apparatus. Such embodiments facilitate more accurate nozzle placement, control, and remote monitoring of the work area during the removal process.

The process of utilizing any of the embodiments of the inventive apparatus described herein typically involves advancing the jet lancing apparatus into and through a body of fluid to the site of the contamination. Such advancement may include advancing the guide tube to the approximate location of the contamination and then advancing the jet lance assembly beyond the distal opening of the guide tube, or, they include advancing the apparatus through manipulation of the positioning member so as to avoid any obstructions until they distal end of the jet lancing apparatus, and particularly the nozzle(s) thereof or in the proximity of the contamination. Note that when advancing a jet lancing apparatus having either a guide tube were a positioning member, axial (forward and backward) as well as nonaxial (sideways or twisting) forces, in combinations thereof, may be applied to the proximal end of the jet lancing apparatus in an attempt to position the nozzle(s) in the proximity of being contamination. High pressure fluid from a source may then be directed from the nozzle(s) toward the contaminants. Thereafter, the loosened particles of contaminate may then be evacuated using a source of negative pressure. During the process, one or more sensors may provide feedback to the personnel operating the jet lancing apparatus as well as the source of high pressure fluid.

The reader can appreciate that the apparatus described herein can remove highly tenacious radioactive material from very small and difficult access areas to achieve superior results in lowering the radiological radiation environment to workers during the performance of inspection and maintenance.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted.

1. An apparatus for removal of contaminants from remote surfaces comprising:
an elongate delivery tube having a lumen extending therethrough and having a first end and a second end connectable to a source of high pressured fluid to allow fluid communication with the delivery tube lumen;
a nozzle operatively coupled to the first end of the delivery tube, the nozzle having at least one orifice in fluid communication with the delivery tube lumen; and
means for positioning the nozzle in the proximity of the contaminants.

2. The apparatus of claim 1 wherein the means for positioning the nozzle comprises:
an elongate guide tube having a lumen extending therethrough; and
wherein the elongate delivery tube is disposed within the lumen of the guide tube.

3. The apparatus of claim 2 wherein the elongate guide tube extends along a main axis and has a distal portion thereof with a bend radius that deviates from the main axis of the guide tube by an off axis angle.

4. The apparatus of claim 3 wherein the distal portion of the guide tube deviates from the main axis of the guide tube by an off axis angle of between 0 degrees and 180 degrees.

5. The apparatus of claim 1 wherein the means for positioning the nozzle comprises:
an elongate positioning member; and
means for securing the positioning member to the elongate delivery tube.

6. The apparatus of claim 1 further comprising:
an adapter mechanism having a lumen extending therethrough,
the adapter mechanism operatively coupled to the elongate delivery tube so that the adapter mechanism lumen is in fluid communication with the lumen of the elongate delivery tube.

7. The apparatus of claim 6 further comprising:
a plurality of nozzles each operatively coupled to the adapter mechanism and in fluid communication with the lumen of the elongate delivery tube.

8. The apparatus of claim 6 wherein the adapter mechanism has a substantially L-shaped lumen extending therethrough.

9. The apparatus of claim 6 wherein the adapter mechanism has a substantially T-shaped lumen extending therethrough.

10. The apparatus of claim 6 wherein the adapter mechanism is coupled intermediate the elongate delivery tube and the nozzle.

11. The apparatus of claim 10 wherein the elongate delivery tube comprises a plurality of sections and wherein the adapter mechanism is coupled intermediate a plurality of elongate delivery tube sections.

12. The apparatus of claim 1 in combination with a source of high pressure fluid connected to the second end of the lumen of the elongate delivery tube.

13. The apparatus of claim 3 further comprising:
any of a sensor, transducer, and imaging device carried at the distal end of the elongate guide tube.

14. The apparatus of claim 1 in combination with a processing unit operatively coupled to any of the sensor, transducer, and imaging device carried at the distal end of the guide tube.

15. A method for removal of contaminants from remote surfaces comprising:
(a) providing the high pressure lancing apparatus comprising:
(i) an elongate delivery tube having a lumen extending therethrough and having a first end and a second end connectable to a source of high pressure fluid so as to allow fluid communication with the delivery tube lumen, the delivery tube having a second end,
(ii) a nozzle operatively coupled to the first end of the delivery tube and having at least one orifice in fluid communication with the lumen of the delivery tube, and
(iii) means for positioning the nozzle;
(b) manipulating the means for positioning the nozzle so that the nozzle is disposed in proximity of the contaminants;
(c) providing high pressure fluid from a source to the lumen of the elongate delivery tube; and
(d) directing high pressure fluid emanating from the nozzle toward the contaminants.

16. The method of claim 15 wherein the means for positioning the nozzle comprises an elongate guide tube having a lumen extending therethrough and into which the elongate delivery tube is disposed and wherein (b) comprises:
(b1) positioning a distal end of the guide tube in the proximity of the contaminants; and
(b2) manipulating the elongate delivery tube within the lumen of the guide tube so that the nozzle extends beyond the distal end of the guide tube.

17. The method of claim 15 wherein the means for positioning the nozzle comprises an elongate positioning member secured to the elongate delivery tube and wherein (b) comprises:
(b1) manipulating the elongate positioning member so that the nozzle is disposed in proximity of the contaminants.

18. The method of claim 15 wherein the apparatus further comprises a sensor carried near the first end of the elongate delivery tube and in communication with a processing unit near the second end of the elongate delivery tube and wherein the method further comprises:
(e) sensing a condition in the proximity of the nozzle; and
(f) transmitting signals associated with the condition from the sensor to the processing unit.

19. The method of claim 15 wherein the nozzle of the lancing apparatus has a plurality of orifices and wherein (b) comprises:
(b1) directing high pressure fluid from one of the nozzle orifices in a direction other than the toward the contaminants.

20. The method of claim 15 wherein the lancing apparatus further comprises a plurality of nozzles operatively coupled to the elongate delivery tube and in fluid communication with the lumen of the elongate delivery tube and wherein (b) comprises:
(b1) directing high pressure fluid from one of the nozzles in a direction substantially opposite the direction from which high pressure fluid is emanating from another of the plurality of nozzles.
